(19) United States
(12) Patent Application Publication
(10) Pub. No.: US 2022/0061302 A1
(43) Pub. Date: Mar. 3, 2022

(54) Method for eradicating insect nests or animal underground channels

(71) Applicant: ANTWAS APS, Ry (DK)

(72) Inventor: Jacob Leth-Espensen, Ry (DK)

(21) Appl. No.: 17/422,901

(22) PCT Filed: Jan. 20, 2020
(86) PCT No.: PCT/EP2020/051240

§ 371 Date: Jul. 14, 2021

(30) Foreign Application Priority Data
Jan. 24, 2019 (DK) PA 2019 00098

(51) Int. Cl. A01M 3/00

(52) U.S. Cl. CPC A01M 3/00

(57) ABSTRACT

A method for eradicating ant and other insect nests includes a) providing a water slurry of phyllosilicate mineral, and optional filler material in a container in slurry communication with a nozzle; b) inserting the nozzle into a channel of an ant or insect nest; and c) injecting the water slurry of phyllosilicate mineral through the nozzle and into the ant or another insect nest. A system for carrying out the method includes a container having a water slurry of phyllosilicate mineral, and optional filler material contained therein, wherein the container includes a discharge orifice configured as a nozzle adapted for dispending the water slurry. The water content of the slurry is within the range of 40-95% w/w, and the dry matter content of phyllosilicate mineral is within the range of 4-60% w/w.

### TECHNICAL FIELD OF THE INVENTION

The present invention relates to a method for eradicating insect nests or animal underground channels.

### BACKGROUND OF THE INVENTION

Various species of ants pose significant problems for man from both an economic, and a health care point of view. A multiplicity of problems arises from ants inhabiting domesticated areas both indoors and outdoors. The outdoor problems are frequently foundation damages resulting in the terrace tiles being displaced. Combating the ants often includes the use of smelly and chemically active baits, and different forms of toxic substances. These agents do not solve the problem of re-habitation of old nests.

It is an object of the present invention to provide an environmentally friendly treatment of insect nests that also prevent their re-habitation.

### SUMMARY OF THE INVENTION

A first aspect relates to a method for eradicating ant and other insect nests or animal underground channels comprising the steps of:
providing a water slurry of phyllosilicate mineral, and optional filler material, in a container in slurry communication with a nozzle;
inserting said nozzle into a channel of an ant or insect nest or into an animal underground channel; and
injecting said water slurry of phyllosilicate mineral through said nozzle and into said ant or another insect nest or into said animal underground channel.

A second aspect relates to a system for eradicating ant and other insect nests or animal underground channels, the system comprising:
a container; and
a water slurry of phyllosilicate mineral, and optional filler material contained therein;

wherein the container comprises a discharge orifice configured as a nozzle adapted for dispensing said water slurry of phyllosilicate mineral, and optional filler material contained in said container.

The present invention provides natural means for eradication of insect nests that also prevent their re-habitation. The present invention may also be used to remove animal underground channels. The water slurry of phyllosilicate mineral, and optional filler material, is thought to seal off the channels of the insect nest, thereby suffocating the insects therein. Due to the expansive capability of phyllosilicate mineral, such as smectite and/or vermiculite, it will continue to seal off the channels of the insect nest as long as there is moisture in the surroundings. Hence, the more water the phyllosilicate mineral is able to absorb, the more its volume increases. In the water slurry formulation, the phyllosilicate mineral is thought to have increased to its maximum volume. Excess of water not absorbed by the phyllosilicate mineral is present to provide a liquid carrier enabling the phyllosilicate mineral to reach deep into the insect nest. The insect nest is typically positioned in the ground. The excess of water in the slurry will therefore be absorbed by the ground forming the walls of the channels, and the phyllosilicate mineral will therefore pack up within the channels.

### DETAILED DESCRIPTION OF THE INVENTION

A first aspect relates to a method for eradicating ant and other insect nests or animal underground channels comprising the steps of:
providing a water slurry of phyllosilicate mineral, and optional filler material, in a container in slurry communication with a nozzle;
inserting said nozzle into a channel of an ant or insect nest or into an animal underground channel; and
injecting said water slurry of phyllosilicate mineral through said nozzle and into said ant or another insect nest or into said animal underground channel.

The clay mineral, which is used in the water slurry of the present invention may be any phyllosilicate mineral known in the art, both synthetic and natural. Preferably, at least a part of the phyllosilicate mineral is expansive phyllosilicate mineral, such as smectite, vermiculite, and mixtures thereof. The water slurry may be an intermediate product from an elastic clay production before the intermediate product is subjected to press filtering. The intermediate product has preferably been processed through a filter allowing particles less than about 100 micrometers to pass therethrough. Alternatively, the water slurry may be produced by hydration of elastic clay.

In one or more embodiments, the density of the water slurry is within the range of 1.25-1.28 g/cm³ (grams per cubic centimeters), such as within the range of 1.26-1.27 g/cm³. This relatively narrow range has shown to provide the best effect for the slurry to reach deep into the insect channels, especially ant channels that are relatively narrow. A slurry with a density above 1.28 g/cm³ tends to adhere to the channel walls while the viscosity may also be important. Hence, preferably the kinematic viscosity of the water slurry is within the range of 2-150 cSt (centistokes), such as within the range of 3-130 cSt, e.g. within the range of 4-110 cSt, such as within the range of 5-100 cSt, e.g. within the range of 6-80 cSt, such as within the range of 7-75 cSt, e.g. within the range of 8-70 cSt, and more preferably within the range of 8-50 cSt.

In the present context, the term “density” refers to the measure of the amount of mass per volume of a particular substance.

Kinematic viscosity is determined by ASTM D445-06 or *ISO 3104 at 20 degrees Celsius (1 atmosphere) and is expressed in centistokes (cSt) or mm²/s.

In one or more embodiments, the water slurry of phyllosilicate mineral for use in the present invention should have a water content of at least 40% w/w, such as within the range of 40-95% w/w, e.g. within the range of 45-90% w/w, such as within the range of 50-85% w/w, e.g. within the range of 55-80% w/w, such as within the range of 60-75% w/w, e.g. within the range of 65-70% w/w, preferably within the range of 40-65% w/w. This water content secures that there is enough water as a liquid carrier of the phyllosilicate mineral, and optional filler material.

In one or more embodiments, the water content of the slurry is at least 40% w/w, such as at least 45% w/w, e.g. at least 50% w/w, such as at least 55% w/w, e.g. at least 60% w/w, such as at least 65% w/w, e.g. at least 70% w/w, such as at least 75% w/w, e.g. at least 80% w/w.

In one or more embodiments, the dry matter content of phyllosilicate mineral is at most 60% w/w, such as within the range of 4-60% w/w, e.g. within the range of 5-55% w/w, such as within the range of 10-50% w/w, e.g. within the range of 15-45% w/w, such as within the range of 20-40% w/w, e.g. within the range of 25-35% w/w, preferably within the range of 30-40% w/w.

In one or more embodiments, the dry matter content of phyllosilicate mineral is at most 60% w/w, such as at most 55% w/w, e.g. at most 50% w/w, such as at most 45% w/w, e.g. at most 40% w/w, such as at most 35% w/w, e.g. at most 30% w/w, such as at most 25% w/w, e.g. at most 20% w/w, such as at most 15% w/w, e.g. at most 10% w/w.

In one or more embodiments, the slurry comprises a filler material. The filler material is not thought to have a specific function, but naturally derived phyllosilicate mineral is often contaminated with various amounts of silt and sand.

In one or more embodiments, the dry matter content of filler material is at most 55% w/w, such as within the range of 10-55% w/w, e.g. within the range of 5-55% w/w, such as within the range of 10-50% w/w, e.g. within the range of 15-45% w/w, such as within the range of 20-40% w/w, e.g. within the range of 25-35% w/w.

In one or more embodiments, the dry matter content of filler material is at most 60% w/w, such as at most 55% w/w, e.g. at most 50% w/w, such as at most 45% w/w, e.g. at most 40% w/w, such as at most 35% w/w, e.g. at most 30% w/w, such as at most 25% w/w, e.g. at most 20% w/w, such as at most 15% w/w, e.g.

at most 10% w/w.

In one or more embodiments, the slurry comprises a filler material, and wherein the filler material is predominantly silt. The dry matter particle size may be regulated by passing it through a filter.

In one or more embodiments, the filler material in the dry matter content has a particle size of less than 100 micrometers, such as less than 90 micrometers, e.g. less than 80 micrometers, such as less than 70 micrometers, e.g. less than 60 micrometers, such as less than 50 micrometers, e.g. less than 40 micrometers, such as less than 30 micrometers, e.g. less than 20 micrometers, such as less than 10 micrometers.

In one or more embodiments, the filler material in the dry matter content has a particle size within the range of 2-70 micrometers, such as within the range of 3-65 micrometers, e.g. within the range of 4-60 micrometers, such as within the range of 5-55 micrometers, e.g. within the range of 10-50 micrometers, such as within the range of 15-45 micrometers, e.g. within the range of 20-40 micrometers.

A second aspect relates to a system for eradicating ant and other insect nests or animal underground channels, the system comprising:
a container; and
a water slurry of phyllosilicate mineral, and optional filler material contained therein;

wherein the container comprises discharge orifice configured as a nozzle adapted for dispensing said water slurry of phyllosilicate mineral, and optional filler material contained in said container.

In one or more embodiments, the water slurry of phyllosilicate mineral further comprises trisodium phosphate, disodium hydrogen phosphate, sodium dihydrogen phosphate, or mixtures thereof. The inventor has found that the water slurry will more easily leave the container when such sodium phosphates are added to the slurry. In one or more embodiments, the dry matter content of trisodium phosphate, disodium hydrogen phosphate, sodium dihydrogen phosphate, or mixtures thereof is at least 0.05% w/w, such as at least 0.1% w/w, e.g. within the range of 0.05-5% w/w, such as within the range of 0.1-4% w/w, e.g. within the range of 0.2-3% w/w, such as within the range of 0.3-2% w/w, e.g. within the range of 0.4-1% w/w, such as within the range of 0.5-1% w/w.

In one or more embodiments, the water slurry of phyllosilicate mineral further comprises poly(dimethylsiloxane). It has been found that this material enhances the slurry's capability to run through the channels of the nest, such that the slurry reaches the deeper parts of the nest. In one or more embodiments, the dry matter content of poly(dimethylsiloxane) is at least 0.05% w/w, such as at least 0.1% w/w, e.g. within the range of 0.05-5% w/w, such as within the range of 0.1-4% w/w, e.g. within the range of 0.2-3% w/w, such as within the range of 0.3-2% w/w, e.g. within the range of 0.4-1% w/w, such as within the range of 0.5-1% w/w.

In one or more embodiments, the container is configured to hold at least 0.5 liters of water slurry of phyllosilicate mineral, and optional filler material, such as at least 1 liter, e.g. at least 2 liters, such as at least 3 liters, e.g. at least 4 liters, such as at least 5 liters, e.g. within the range of 0.5-10 liters, such as within the range of 1-9 liters, e.g. within the range of 2-8 liters, such as within the range of 3-7 liters, e.g. within the range of 4-6 liters. The container should be of a size suitable for handheld use. The inventor has found that a small ant nest will need a treatment with about 0.5-1 liter of water slurry of phyllosilicate mineral, and optional filler material, while older, and thereby larger, ant nests need treatment with about 5-10 liters (some up to 20 liters) of water slurry of phyllosilicate mineral, and optional filler material.

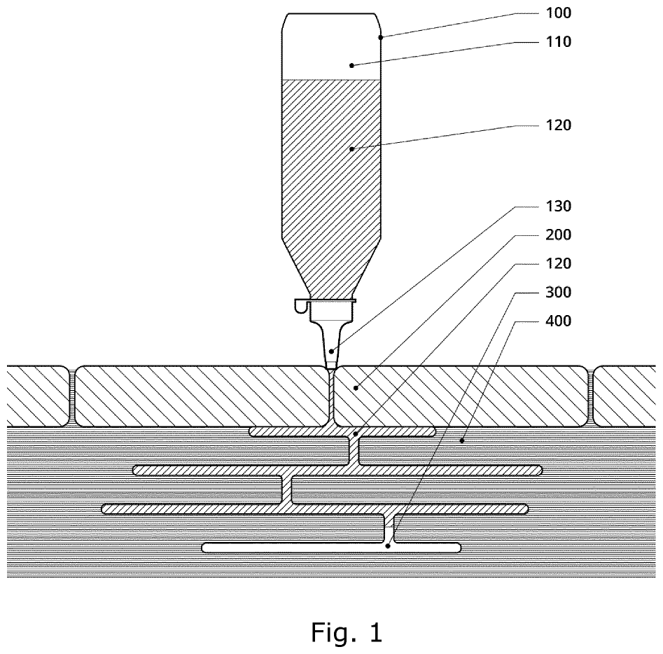

In FIG. 1, an exemplary system for eradicating ant and other insect nests according to the present invention is shown. The system comprises a container 100 with a water slurry 120 of phyllosilicate mineral, and filler material contained therein. The water slurry 120 is produced by hydrating elastic clay such that the water content is about 65% w/w, and the dry matter content (about 35% w/w) has a particle size of less than 100 micrometers. The dry matter content of filler material is at most 60% w/w.

The container 100 comprises a discharge orifice configured as a nozzle 130 adapted for dispensing said water slurry 120. The nozzle 130 is positioned in a channel 300 opening in the joint between two terrace tiles 200. The channel 300 is seen extending into the ground 400 beneath the terrace tiles 200. The water slurry 120 is already filling the channels 300, displacing the air that enters the container 100. In general, it is preferred that the container 100 does not contain other openings than the discharge orifice, as it leads to a more controlled filling of the channels. Hence, the container is preferably airtight except from the discharge orifice, i.e. no other air openings are present.

It should be noted that embodiments and features described in the context of one of the aspects of the present invention also apply to the other aspects of the invention.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

1. A method for eradicating ant and other insect nests, comprising the steps of:
providing a water slurry of phyllosilicate mineral, and optional filler material in a container in slurry communication with a nozzle;
inserting said nozzle into a channel of an ant or insect nest; and
injecting said water slurry of phyllosilicate mineral through said nozzle and into said ant or another insect nest;
wherein the water content of the slurry is within the range of 40-95% w/w, and the dry matter content of phyllosilicate mineral is within the range of 4-60% w/w.

2. The method according to claim 1, wherein the density of the water slurry is within the range of 1.25-1.28 g/cm³ grams per cubic centimeters.

3. The method according to claim 1, wherein the kinematic viscosity of the water slurry is within the range of 5-70 cSt.

4. The method according to claim 1, wherein the water slurry is an intermediate product from an elastic clay production before the intermediate product is subjected to press filtering.

5. The method according to claim 1, wherein the the water slurry is produced by hydration of elastic clay.

6. The method according to claim 1, wherein the phyllosilicate mineral comprises smectite, vermiculite, or mixtures thereof.

7. The method according to claim 1, wherein the water slurry includes a filler material having a particle size of less than 100 micrometers.

8. The method according to claim 1, wherein the slurry comprises a filler material, and wherein the filler material is predominantly silt.

9. A system for eradicating ant and other insect nests or animal underground channels, the system comprising:
a container, comprising
a water slurry of phyllosilicate mineral, and optional filler material contained therein;
wherein said container comprises a discharge orifice configured as a nozzle adapted for dispensing said water slurry of phyllosilicate mineral, and optional filler material contained in said container;
wherein the water content of the slurry is within the range of 40-95% w/w, and the dry matter content of phyllosilicate mineral is within the range of 4-60% w/w.

10. The system according to claim 9, wherein the water slurry of phyllosilicate mineral further comprises trisodium phosphate, disodium hydrogen phosphate, sodium dihydrogen phosphate, or mixtures thereof.

11. The system according to claim 9, wherein the water slurry of phyllosilicate mineral further comprises poly(dimethylsiloxane).

12. The system according to claim 9, wherein the water slurry is produced by hydration of elastic clay.
